(19) United States
(12) Patent Application Publication
(10) Pub. No.: US 2005/0183238 A1
(43) Pub. Date: Aug. 25, 2005

(54) Adjustable hinge

(76) Inventors: Timothy E. McCue, Lowell, MA (US); Joseph R. McCue, Lowell, MA (US)

Correspondence Address: Joseph E. Funk, PO Box 661, Londonderry, NH, 03053, US

(21) Appl. No.: 10/828,589

(22) Filed: Apr. 22, 2004

Related U.S. Application Data
(60) Provisional application No. 60/546,923, filed on Feb. 23, 2004.

(51) Int. Cl. E05D 7/04

(52) U.S. Cl. 16/236

(57) ABSTRACT

Manually adjustable hinges for gates, doors and other hinge applications where a first hinge is adjustable using an ordinary wrench in a first direction coaxial with the hinge pin, and as the first hinge is adjusted in the first direction the other hinges follows the movement of the first hinge to prevent the first hinge from binding the other hinges. All hinges are manually adjustable in a second direction perpendicular to the hinge pin using the wrench.

### CROSS REFERENCE TO RELATED APPLICATION

This utility patent application claims rights under 35 U.S.C. 119(e) from U.S. provisional patent application No. 60/546,923 entitled “Adjustable Hinge”, and filed Feb. 23, 2004.

### FIELD OF THE INVENTION

This invention relates to an adjustable hinge that provides the ability to adjust a hinge in two orthogonal directions after the hinge is attached to a fixed member and a swinging member.

### BACKGROUND OF THE INVENTION

In mounting a door to a frame, it is often difficult to obtain precisely the desired position of the door relative to the frame. For this reason, it is common for door manufacturers to market pre-hung doors in which the door is mounted to the frame at the factory under controlled conditions so that precise positioning of the door can be obtained. The door and frame assembly is then shipped as a unit to the construction site for installation into an opening formed in a wall.

However, there are times when pre-hung doors cannot be employed and it is necessary to hang a door in an existing opening in which a frame has been constructed. In addition, not all doors for new construction are available in pre-hung form, making it necessary to construct a frame within an opening and to fit the door into the frame. In these instances, obtaining precise positioning of the door within the frame is a difficult and time consuming task even for the most skilled workman.

Hinges are also used to mount metal or wooden swinging gates to posts for outdoor usage. Such gates must be positioned and mounted as they are being installed. It is difficult to precisely obtain the desired position of the gate relative to the post to which it is being mounted. Since such gates are not received pre-hung alike doors and frames used indoors, there is always some difficulty in mounting such gates. In addition, even after gates are hung, the poles to which the gates are attached via hinges often shift as the earth settles in which the poles are set. As a result the bottom of the gate sags down and too often hits the ground and/or hits an adjacent pole of the fence to which latching side of the gate latches. This is an unacceptable situation.

Thus, there is a need in the art for an adjustable hinge that makes it much easier to install a door, gate or swinging member and to readjust the positioning of the door, gate or swinging member at a later time.

### DESCRIPTION OF THE DRAWING

The invention will be better understood upon reading the following detailed description in conjunction with the drawing in which:

FIG. 1 is a blow up drawing showing the individual parts that make up an adjustable hinge;

FIG. 2 shows an adjustable hinge assembled from the parts shown in FIG. 1;

FIG. 3 a blow up drawing showing the individual parts that make up a hinge that self adjusts as a mating hinge is adjusted; and

FIG. 4 shows an assembled self adjusting hinge assembled from the parts shown in FIG. 3;

### DETAILED DESCRIPTION

In the following detailed description the novel hinges described are described as being used with a door or gate, but the hinge may be used in any application where one member is connected to another member and must move in a hinged fashion therewith. All the parts of the preferred embodiment of the hinges disclosed herein are made from metal, but in alternative embodiments of the invention where light loads are contemplated, some of the parts may be made from tough plastics. Further, while the novel hinges are described hereinafter as being used with a door or gate, they hinges may be used with a swinging member that swings about its top edge.

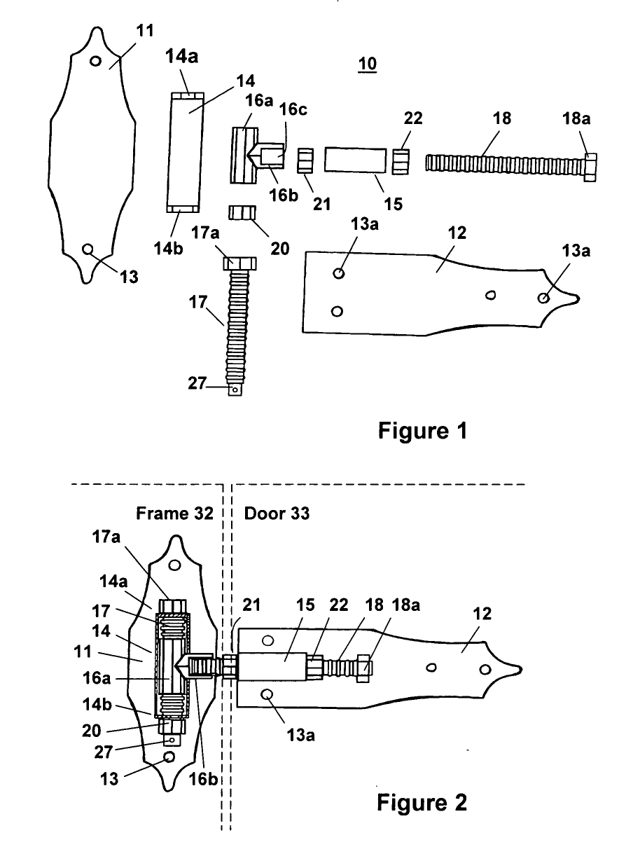

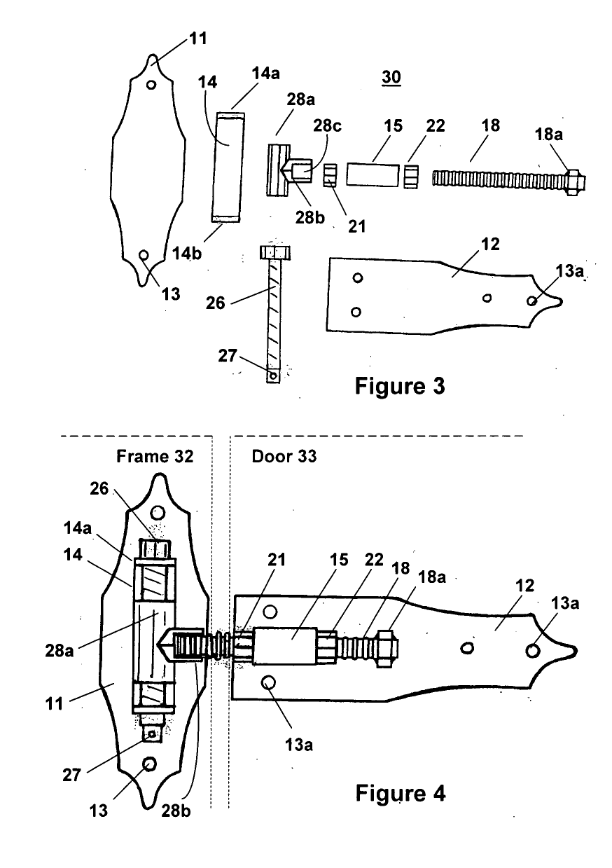

FIGS. 1 and 2 show one embodiment of our novel manually adjustable hinge 10, and FIGS. 3 and 4 show a second embodiment of the hinge 30 which self adjusts. In use, at least one manually adjustable hinge 10 shown in FIGS. 1 and 2 is utilized with a gate or door 33, and preferably hinge 10 would be the uppermost hinge of a set of hinges, and the self adjusting hinge 30 shown in FIGS. 3 and 4 would be used for all middle and lower hinges of the set of hinges. The novel hinges 10, 30 may be used in different applications where a first member is connected to a second member in a hinged relationship, no matter if the two members are vertical, horizontal or at any other orientation. When there are two or more hinges 10, 30 used, then hinge 10 shown in FIGS. 1 and 2 is used as one of the hinges, no matter where is located with relationship to the other hinges 30.

In the following description FIGS. 1 and 2 show an upper adjustable hinge 10, and FIGS. 3 and 4 show a middle or lower hinge 30. Some of the parts in the different figures appear to be the same have the same element numbers and some do not. Those parts, such as metal plates 11 and 12, bolt 18, and nuts 18a, 21 and 22 are the same for both hinges 10 and 30. In addition bracket 14 is the same. Although the first connecting member first connecting member T-bracket 16 in FIG. 1 and first connecting member T-bracket 28 in FIG. 2 appear to be the same they are not, thus the different element numbers. A hole through vertical portion 16a of first connecting member T-bracket 16 is threaded while the hole through vertical portion 28a of first connecting member T-bracket 28 is not threaded but smooth.

In Figure shown 1 is shown a blow up drawing showing the individual parts that make up a manually adjustable hinge 10. There is a metal plate 11 that is mounted to a door jam, post or other fixed member 33 using screws or bolts (not shown) that pass through holes 13. While two holes 13 are shown there may be more than two holes.

There is a plate 12 that is mounted to a swinging door, gate or other swinging member 32 using screws or bolts that pass through holes 13a. While four holes 13a are shown there may be more or less than four holes 13a.

When manually adjustable hinge 10 is to be used to mount a metal gate, door or other swinging member 33 to a doorjamb, post or other fixed member 32 that is also made of metal, rather than wood or other material, metal plates 11 and 12 may be eliminated. Instead metal bracket 11 may be welded or otherwise fastened to a metal post, door jamb or other fixed member 33; and metal bracket 12 may be welded or otherwise fastened to a doorjamb, post or other fixed member 32. Alternatively, upper hinge 10 may be attached to a combination of a wooden or metal gate or door 33 and a wooden or metal post or jamb 32. As appropriate one of metal plates 11 and 12 may be eliminated for such configurations.

Bracket 14 is U-shaped with its legs 14a and 14b being vertical to the plane of plate 11. Bracket 14 is made very sturdy because it bears the weight of a gate, door or other swinging member 33. Legs 14a and 14b of bracket 14 are oriented perpendicular to the plane of plate 11 and each has a hole there through (not shown) that is larger than the diameter of a hinge pin bolt 17. Hinge pin bolt 17 passes through the hole through each of legs 14a and 14b as shown in FIG. 2 when hinge 10 is assembled. Bracket 14 is welded to metal plate 11 as shown in FIG. 2, or is welded directly to a metal post or doorjamb 32 as described above. During assembly the hex headed hinge pin bolt 17 passes downward, first through the hole through upper leg 14a, then passes through a threaded hole that passes coaxially through the vertical portion 16a of first connecting member T-bracket 16, and finally passes through the hole through lower leg 14b. This is shown in and described with reference to FIG. 2.

First connecting member T-bracket 16 also has a horizontal portion 16b in which is a threaded hole 16c the purpose of which is described hereinafter with reference to FIG. 2. Briefly, threaded member 18 screws into threaded hole 16c and is preferably welded therein forming an extension to first connecting member 16 that is the main point of attachment for or gate 33 to a frame or post 32.

Second connecting member bracket 15 is made of strong metal, is tubular in shape and has a hole coaxially through it. The diameter of threaded extension 18 permits it to pass through the hole. Second connecting member bracket 15 is welded to metal plate 12 as shown in FIG. 2.

Threaded extension 18 is headless and its left end passes through second connecting member bracket 15 and screws into threaded hole 16c of first connecting member T-bracket 16 where it is welded. Thereafter, during assembly nut 21 is first turn onto threaded member 18, then second connecting member bracket 15 welded onto plate 12 is slid onto threaded extension 18 so extension 18 passes through the longitudinal hole through bracket 15. Then nut 22 is threaded onto the outer end of extension 18, and finally locked nut 18a is turned onto the outer end of threaded extension 18 as shown in FIG. 1. The two nuts 21 and 22 function as locking nuts and are used to lock threaded extension 18 to second connecting member bracket 15.

FIG. 2 shows an assembled upper hinge 10 made from the individual parts shown in FIG. 1 used to mount a door 33 to a frame 32. During assembly U-bracket 14 is first welded to metal plate 11 as shown, and tubular second connecting member bracket 15 is welded to metal plate 12 as shown. Hinge pin bolt 17 is first inserted down though the hole through upper leg 14a of U shaped bracket 14. The threaded shaft of hinge pin bolt 17 is then screwed through the mating threaded hole longitudinally through portion 16a of first connecting member T-bracket 16. Hinge pin bolt 17 is continued to be screwed through portion 16a and then passes through the hole (not shown) through lower leg 14b of U shaped bracket 14. Nut 20 is then screwed onto the end of bolt hinge pin 17. There is a hole 27 through the end of hinge pin 17 through which a cotter pin (not shown) is then inserted that prevents nut 20 from accidentally being removed from hinge pin 17. Nut 20 functions as a jam nut after the assembly of bracket 10 in FIG. 2 and prevents hex headed hinge pin bolt 17 from turning about its longitudinal axes after nut 20 is turned tightly against lower leg 14b. Hinge pin bolt 17 is used to manually adjust the vertical position of first connecting member T-bracket 16 and thereby adjust the vertical position of a gate or door as described hereinafter.

During assembly second connecting member bracket 15 is welded to metal plate 12 as shown in FIG. 2 as previously described. Nut 21 is then turned onto threaded extension 18 until it is positioned approximately as shown. Bracket 15 on plate 12 is then slipped over threaded extension 18 until it rests against nut 21. Nut 22 is then turned onto threaded extension 18 until it is approximately as shown against the right end of second connecting member bracket 15. Nuts 21 and 22 function as locking jam nuts as described hereinafter and are used for the horizontal adjustment of the gate or door 33 on which hinge 10 is mounted. Finally, lock nut 18a is turned onto the right end of threaded extension 18. Alternately, a standard nut with a thread lock compound on its threads may be utilized.

When an upper hinge 10 is utilized its metal plate 11 is attached to a fence post, door jamb or other solid member 32, and its metal plate 12 is attached to a gate, door or other swinging member 33 as previously described. After mounting, to adjust the height of the gate, door or other member 33 off the floor or ground, nut 20 is first loosened and the hexagonal head 17a of hinge pin bolt 17 is turned clockwise or counter clockwise. Since the threads of hinge pin bolt 17 are being turned in the mating threads in the interior of the vertical part of bracket portion 16a, first connecting member T-bracket 16 moves up or down along the threads of hinge pin bolt 17 as the bolt is turned. This moves the gate, door or other swinging member 33 attached to metal plate 12 up or down to adjust its height from the ground or floor. When hinge pin bolt 17 as a right handed thread, as the head 17a is turned clockwise looking down from the top in FIG. 2, first connecting member T-bracket 16 moves upwards along hinge pin bolt 17. Visa versa, when head 17a is turned counter clockwise looking down from the top in FIG. 2, first connecting member T-bracket 16 moves downward along hinge pin bolt 17. The head 17a is a standard hexagonal head and may be turned with a standard box wrench, open end wrench or adjustable wrench, thus no special tools are required to accomplish the vertical adjustment of hinge 10. The same wrench is used to loosen or tighten locking nut 20.

When the vertical adjustment is completed, using the same wrench nut locking 20 is turned so that it is tight against lower leg 14b of bracket 14 to function as a jam nut to prevent hinge pin bolt 17 from rotating thereafter. This is important because any later rotation of bolt 17 will change the vertical adjustment of the door, gate or other swinging member 33.

If at a later time it is desired to readjust the height of the gate, door or other swinging member 33 locking nut 20 is first loosened and then head 17a of hinge pin bolt 17 is rotated to move first connecting member T-bracket 16 up or down along the threads of hinge pin bolt 17 as previously described. When the height adjustment is completed locking nut 20 is again tightened against lower leg 14b to prevent hinge pin bolt 17 from rotating. U-bracket 14 is made of heavy gauge metal that it is not deformed when locking nut 20 is tightened against lower leg 14b. It is also important that bracket 14 be made of heavy gauge metal because a lot of weight of the gate or door 33 is supported by this bracket.

To adjust the horizontal distance of the gate, door or other swinging member 33 to which metal plate 12 is fastened, from metal plate 11 and the post or jamb 32 to which is connected, locking nuts 21 and 22 are turned so they are backed away from either end of second connecting member bracket 15 and are not jammed against bracket 15. If the gate or door is to be moved away from plate 11 and the post or doorjamb 32 to which is attached, locking nut 22 is turned to move it to the right. Then nut 21 is then turned to move to the right and push against the left end of bracket 15 which thereby forces plate 12 and the gate or door 33 attached to it to the right.

Conversely, if plate 12 and the gate or door 33 to which it is attached is to be moved closer to the post or jamb 32, nut 21 is turned to move it to the left and nut 22 is turned against the right end of bracket 15 forcing it closer to the post or doorjamb 32. When the upper part of the gate or door 33 is spaced the correct distance from the post 32, locking nut 21 is turned against the left end of second connecting member bracket 15. Locking nuts 21 and 22 are then turned slightly against bracket 15, thereby jamming the nuts 21 and 22 so they are prevented from turning. This maintains the horizontal adjustment of hinge 10.

When the gate or door 33 is spaced the correct distance from the post or jamb 32, locking nut 22 is turned tightly against the right end of second connecting member bracket 15. Locking nuts 21 and 22 are then both locked against bracket 15, thereby jamming the locking nuts so they are prevented from inadvertently turning. This maintains the new horizontal adjustment of hinge 10.

In FIG. 3 is shown a blow up drawing showing the individual parts that make up a self adjusting lower or middle hinge 30. There is a metal plate 11 that is mounted to a post, door jam or other fixed member 32 using screws or bolts that pass through holes 13. While two holes 13 are shown there may be more than two holes.

There is a plate 12 that is mounted to a swinging door, gate or other swinging member 33 using screws or bolts that pass through holes 13a. While four holes 13a are shown there may be more or less than four holes 13a.

When self adjusting hinge 30 is to be mounted to a door or gate 33 that is made of metal, rather than wood or other material, metal plates 11 and 12 may be eliminated. Instead metal bracket 14 may be welded or otherwise fastened to a post, doorjamb or other fixed member 32 made of metal, and metal bracket 15 may be welded or otherwise fastened to a metal gate, door or other swinging member 33 made of metal. Alternatively, upper hinge 10 may be attached to a combination of a wooden or metal gate/door 33 and a wooden or metal post or jamb 32. As appropriate the one of metal plates 11 and 12 may be eliminated for such configurations.

Bracket 14 is U-shaped with its legs 14a and 14b being vertical to the plane of plate 11. Bracket 14 is made very sturdy because it helps bear the weight of a gate, door or other swinging member 32. Legs 14a and 14b of bracket 14 are oriented perpendicular to the plane of plate 11 and each has a hole there through (not shown) that is slightly larger than the diameter of a non-threaded hinge pin 26. Hinge pin 26 passes through the hole through each of legs 14a and 14b as shown in FIG. 2 when hinge 30 is assembled. During assembly the hinge pin 26 passes first through the hole through upper leg 14a, then passes through a hole that passes coaxially through vertical portion 28a of first connecting member T-bracket 28, then passes through the hole through lower leg 14b.

First connecting member T-bracket 28 also has a horizontal portion 28b in which is a threaded hole 28c the purpose of which is described hereinafter with reference to FIG. 4. Briefly, threaded extension 18 screws into threaded hole 28c and is preferably welded therein.

Second connecting member bracket 15 is made from strong metal, is tubular in shape and has a hole coaxially through it. The diameter of threaded extension 18 permits it to pass through the hole. Bracket 15 is welded to metal plate 12 as shown in FIG. 4.

Threaded extension 18 is headless and its left end passes through second connecting member bracket 15 and screws into threaded hole 28c of first connecting member T-bracket 28 where it is welded. Thereafter, during assembly nut 21 is first turn onto threaded extension 18, then bracket 15 welded onto plate 12 is slid onto threaded extension 18 so extension 18 passes through the longitudinal hole through bracket 15. Then nut 22 is threaded onto the outer end of extension 18, and finally lock nut 18a is turned onto the outer end of threaded member 18 as shown in FIG. 4. The two nuts 21 and 22 function as locking nuts and are used to lock threaded extension 18 to bracket 15.

FIG. 4 shows an assembled lower or middle hinge 30 made from the individual parts shown in FIG. 3. During assembly U-bracket 14 is first welded to metal plate 11 as shown, and second connecting member bracket 15 is welded to metal plate 12 as shown. Hinge pin 26 is inserted down though the hole (not shown) through upper leg 14a of U-shaped bracket 14, through the non-threaded longitudinal hole through bracket piece 28a and then passes through the hole (not shown) through lower leg 14a of U-shaped bracket 14. There is a hole 27 through the end of hinge pin 26 through which a cotter pin (neither shown) is inserted that prevents hinge pin 26 from being removed from bracket 14. In an alternative embodiment of the invention, to minimize the number of different parts between the adjustable hinge shown in FIGS. 1 and 2 and the self adjusting hinge shown in FIGS. 3 and 4, the threaded hinge pin bolt 17 and nut 20 may be used in lieu of hinge pin 26. In this case the only difference between the two hinges is that first connecting member T-bracket 28 is not threaded through its vertical hole.

During assembly and bracket piece 15 is welded to metal plate 12 as previously described. Nut 21 is turned onto threaded extension 18 until it is approximately as shown. Piece 15 on plate 12 is then slipped over threaded extension 18 until it rests against nut 21. Nut 22 is then turned onto threaded extension 18 until it is approximately as shown against the right end of bracket piece 15. Nuts 21 and 22 function as locking jam nuts as described hereinafter and are used for the horizontal adjustment of the door or gate on which hinge 30 is mounted. Finally, lock nut 18a turned onto the right end of threaded extension 18. Alternately, a standard nut with a thread lock compound on its threads may be utilized.

When a hinge 30 is utilized its metal plate 11 is attached to a fence post, doorjamb or other solid member 33, and its metal plate 12 is attached to a gate, door or other swinging member 32 as previously described. With hinge 30 there is no vertical adjustment to set the height of the gate or door 33 off the floor or ground. That adjustment is made solely with threaded hinge pin bolt 17 of upper hinge 10 as previously described. As first connecting member T-bracket 16 in FIG. 2 is moved up or down as previously described with reference to FIG. 2 to adjust the height of the gate or door 33, first connecting member T-bracket 28 of hinge 30 automatically moves vertically along hinge pin 26. By using the vertically self adjusting hinge 30 with adjustable hinge 10 there is never a problem of the vertical adjustments of two adjustable hinges 10 straining against each other.

To adjust the horizontal distance of the gate, door or other swinging member 33 to which metal plate 12 is fastened, from metal plate 11 and the post or jamb 32 to which is connected, locking nuts 21 and 22 are turned so they are backed away from either end of metal bracket 15 and are not jammed against bracket 15. If the gate or door 33 is to be moved away from plate 11 and the post or doorjamb 32 to which is attached, locking nut 22 is turned to move away from bracket 15. Then nut 21 is then turned to move to the right and push against the left end of bracket 15 which thereby forces plate 12 and the gate or door 33 attached to it to the right.

Conversely, if plate 12 and the gate or door 33 to which it is attached is to be moved closer to the post or jamb 32, nut 21 is turned closer to first connecting member T-bracket 28 and nut 22 is turned against the right end of bracket 15 forcing it closer to the post or jamb 32. When the lower part of the gate or door 33 is spaced the correct distance from the post 32 locking nut 21 is turned against the left end of bracket piece 15. Locking nuts 21 and 22 are then turned slightly against bracket 15, thereby jamming the nuts 21 and 22 so they are prevented from turning. This maintains the new horizontal adjustment of hinge 30.

After installation of a set of hinges 10 and 30 to a post and gate 33 the post may shift in the ground and the outer, bottom end of the gate 33 may sag and touch the ground. To correct for this sag upper hinge 10 and middle and lower hinges 30 may be re-adjusted. Upper hinge 10 is re-adjusted to move plate 12 closer to plate 11 while middle and lower hinges 30 or re-adjusted to move them away from their plate 11.

In FIGS. 1-4 hinges 10 and 30 are shown in the orientation they would be to mount a gate on the right side of a post, jamb or other fixed member 32. To mount these hinges so that a gate 33 is on the left side of a post, jamb or other fixed member 32, before mounting the hinges their plate 12 with bracket 15 are rotated one hundred eighty degrees about extension 18 and are then swung about their hinge pin bolt 17 or hinge pin 26 to be to the left of their plate 11 and bracket 14.

While what has been described hereinabove is the preferred embodiment of the invention, it will be understood that numerous changes may be made without departing from the spirit and scope of the invention.

1. An adjustable hinge for mounting a first member to a second member, comprising:
a first plate that is attached to the first member;
a second plate that is attached to the second member;
a hinge pin; and
a first connecting member associated with the first plate and having a hole through which the hinge pin passes to pivotally attach the first connecting member to the first plate, the first connecting member having an extension; and
a second connecting member associated with the second plate and having a hole through which the first connecting member extension passes;
wherein the hinge pin is used as an adjustment to move the first connecting member along the hinge pin and thereby adjust the position of the first member with respect to the second member in a first direction; and wherein the position of the second connecting member is changed with respect to the first connecting member extension to thereby adjust the position of the first member with respect to the second member in a second direction.

2. The adjustable hinge of claim 1 wherein the hinge pin has a longitudinal axis and is threaded, and the hole through the first connecting member is also threaded and the hinge pin is screwed there through, and to accomplish the adjustment of the first member in the first direction with respect to the second member the hinge pin is turned about its longitudinal axis and thereby causes the second connecting member to move along the hinge pin.

3. The adjustable hinge of claim 2 wherein the first connecting member extension is threaded and there is a nut threaded onto the extension at either side of the hole through the second connecting member, the nuts are normally tightened against the second connecting member at either side of the hole there through to prevent the second connecting member from moving along the first connecting member threaded extension, and wherein one nut at one side of the hole is loosened and turned away from the side of the hole it is adjacent to while the nut at the other side of the hole is tightened against the second connecting member to move it along the first connecting member threaded extension and thereby adjust the position of the first member with respect to the second member in a second direction, and when the second connecting member is properly repositioned along the first connecting member threaded extension the one nut is again tightened against the second connecting member to lock the second connecting member with respect to the first connecting member.

4. The adjustable hinge of claim 1 wherein the first connecting member extension is threaded and there is a nut threaded onto the extension at either side of the hole through the second connecting member, the nuts are normally tightened against the second connecting member at either side of the hole there through to prevent the second connecting member from moving along the first connecting member threaded extension, and wherein one nut at one side of the hole is loosened and turned away from the side of the hole it is adjacent to while the nut at the other side of the hole is tightened against the second connecting member to move it along the first connecting member threaded extension and thereby adjust the position of the first member with respect to the second member in a second direction, and when the second connecting member is properly repositioned along the first connecting member threaded extension the one nut is again tightened against the second connecting member to lock the second connecting member with respect to the first connecting member.

5. An adjustable hinge for mounting a door or gate to a fixed member, comprising:
a first plate that is attached to the fixed member;
a second plate that is attached to the edge of a door or gate;
a hinge pin; and
a first connecting member associated with the first plate and having a hole through which the hinge pin passes to pivotally attach the first connecting member to the first plate, the first connecting member having an extension; and
a second connecting member associated with the second plate and having a hole through which the first connecting member extension passes;
wherein the hinge pin is used as an adjustment to move the first connecting member along the hinge pin and thereby adjust the position of the door or gate with respect to the fixed member in the vertical direction; and wherein the position of the second connecting member is changed with respect to the first connecting member extension to thereby adjust the position of the door or gate with respect to the fixed member in the horizontal direction.

6. The adjustable hinge of claim 5 wherein the hinge pin has a longitudinal axis and is threaded and the hole through the first connecting member is also threaded and the hinge pin is screwed there through, and to accomplish the adjustment in the vertical direction the hinge pin is turned about its longitudinal axis and thereby cause the first connecting member to move vertically along hinge pin.

7. The adjustable hinge of claim 6 wherein the extension of the first connecting member is threaded and there is a nut on the extension at either side of the hole through the second connecting member, the nuts are normally tightened against the second connecting member at either side of the hole there through to prevent the second connecting member from moving along the first connecting member threaded extension, and wherein one nut at one side of the hole is loosened and turned away from the side of the hole it is adjacent to while the nut at the other side of the hole is tightened against the second connecting member to move it along the first connecting member threaded extension and thereby adjust the position of the door or gate with respect to the fixed member in the horizontal direction, and when the second connecting member is properly repositioned along the threaded extension the one nut is again tightened against the second connecting member to lock the second connecting member with respect to the first connecting member.

8. The adjustable hinge of claim 5 wherein the first connecting member extension is threaded and there is a nut on the extension at either side of the hole through the second connecting member, the nuts are normally tightened against the second connecting member at either side of the hole there through to prevent the second connecting member from moving along the first connecting member threaded extension, and wherein one nut at one side of the hole is loosened and turned away from the side of the hole it is adjacent to while the nut at the other side of the hole is tightened against the second connecting member to move it along the threaded extension of the first connecting member and thereby adjust the position of the door or gate with respect to the fixed member in the horizontal direction, and when the second connecting member is properly positioned along the first connecting member threaded extension the one nut is again tightened against the second connecting member to lock the second connecting member with respect to the first connecting member.

9. An adjustable hinge for mounting a door or gate to a fixed member, comprising:
a first plate that is attached to the fixed member;
a second plate that is attached to the edge of a door or gate;
a hinge pin; and
a first connecting member associated with the first plate and having a hole through which the hinge pin passes to pivotally attach the first connecting member to the first plate, the first connecting member having an extension; and
a second connecting member associated with the second plate and having a hole through which the first connecting member extension passes;
wherein the first connecting member moves freely along the hinge pin as the door or gate is adjusted with respect to the fixed member in the vertical direction; and wherein the position of the second connecting member is changed with respect to the first connecting member extension to thereby adjust the position of the door or gate with respect to the fixed member in the horizontal direction.

10. The adjustable hinge of claim 9 wherein the extension of the first connecting member is threaded and there is a nut on the threaded extension at either side of the hole through the second connecting member, the nuts are normally tightened against the second connecting member at either side of the hole there through to prevent the second connecting member from moving along the first connecting member threaded extension, and wherein one nut at one side of the hole is loosened and turned away from the side of the hole it is adjacent to while the nut at the other side of the hole is tightened against the second connecting member to move it along the first connecting member threaded extension and thereby adjust the position of the door or gate with respect to the fixed member in the horizontal direction, and when the second connecting member is properly positioned along the threaded extension the one nut is again tightened against the second connecting member to lock the second connecting member with respect to the first connecting member.

11. An adjustable hinge set for mounting a door or gate to a fixed member, comprising:
a first hinge that is attached to the fixed member and to the door or gate, the first hinge being manually adjustable to adjust the position of the door or gate with respect to the fixed member in both a vertical and horizontal direction; and
a second hinge that is attached to the fixed member and to the door or gate, and as the first hinge is adjusted to move the door or gate in the vertical direction the second hinge follows the first hinge and does not have to be manually adjusted to change the vertical position of the door or gate.

12. The adjustable hinge set of claim 111 wherein the first hinge comprises:
a frame plate that is attached to the fixed member;
a door plate that is attached to the edge of a door or gate;
a hinge pin; and
a first connecting member associated with the frame plate and having a hole through which the hinge pin passes to pivotally attach the first connecting member to the frame plate, the first connecting member having an extension; and
a second connecting member associated with the second plate and having a hole through which the first connecting member extension passes;
wherein the hinge pin is used as an adjustment to move the first connecting member along the hinge pin and thereby adjust the position of the door or gate with respect to the fixed member in the vertical direction; and wherein the position of the second connecting member is changed with respect to the first connecting member extension to thereby adjust the position of the door or gate with respect to the fixed member in the horizontal direction.

13. The adjustable hinge set of claim 12 wherein the second hinge comprises:
a first plate that is attached to the fixed member;
a second plate that is attached to the edge of a door or gate;
a hinge pin; and
a first connecting member fastened to the first plate and having a hole through which the hinge pin passes to pivotally attach the first connecting member to the first plate, the first connecting member having an extension; and
a second connecting member fastened to the second plate and having a hole through which the first connecting member extension passes and is secured in the hole;
wherein the first connecting member is freely moveable along the hinge pin, and as the first hinge is adjusted in the vertical direction the second hinge follows the first hinge by the first connecting member moving freely along the hinge pin.

14. The adjustable hinge set of claim 13 wherein the first hinge pin has a longitudinal axis and is threaded and the hole through the first hinge first connecting member is also threaded and the hinge pin is screwed there through, and to accomplish the adjustment in the vertical direction the first hinge pin is turned about its longitudinal axis and thereby causes the first hinge first connecting member to move vertically along the first hinge pin.

15. The adjustable hinge of claim 14 wherein the extension of the first connecting member for both the first hinge and the second hinge is threaded and there is a nut threaded onto the extension at either side of the hole through the second connecting member, the nuts are normally tightened against the second connecting member at either side of the hole there through to prevent the second connecting member from moving along the threaded extension of the first connecting member, one nut at one side of the hole is loosened and turned away from the side of the hole it is adjacent to while the nut at the other side of the hole is tightened against the second connecting member to move it along the threaded extension of the first connecting member and thereby adjust the position of the door or gate with respect to the fixed member in the horizontal direction, and when the second connecting member is properly positioned along the threaded extension the one nut is again tightened against the second connecting member to lock the second connecting member with respect to the extension of the first connecting member.
